(19) United States
(12) Patent Application Publication
(10) Pub. No.: US 2020/0179823 A1
(43) Pub. Date: Jun. 11, 2020

(54) DEMULSIFIER INJECTION SYSTEM

(71) Applicant: SCHLUMBERGER TECHNOLOGY CORPORATION, Sugar Land, TX (US)

(72) Inventors: Joseph Paul Bailey, Cundinamarca (CO); Gary Potten, Spring, TX (US); Stuart Fraser Wright, East Sussex (GB); Erik L. Sellman, The Woodlands, TX (US); Luis Eduardo Caires-Fernandez, Cypress, TX (US); Secil Comert, Cypress, TX (US); S. Pavankumar B. Mandewalkar, Houston, TX (US)

(21) Appl. No.: 16/212,173

(22) Filed: Dec. 6, 2018

(51) Int. Cl. B01D 17/04; B01F 5/02; B01F 5/06; B01F 3/08; C10G 33/04

(52) U.S. Cl. CPC B01D 17/047; B01F 5/0275; B01F 2215/0036; B01F 3/0865; C10G 33/04; B01F 5/061

(57) ABSTRACT

A mixing apparatus and method of mixing additives are described herein. The mixing apparatus comprises a mixing conduit having a wall, a first end, and a second end opposite the first end. A fluid inlet is formed in the wall between the first end and the second end. A fluid outlet is also formed in the wall between the first end and the second end. An injection conduit fluidly connects the fluid inlet with the fluid outlet. A pump is disposed to pump fluid in the injection conduit. An additive conduit is fluidly coupled to the injection conduit.

### FIELD

Embodiments of the present invention generally relate to oil/water separation. Specifically, methods and apparatus for demulsifier injection are described.

### BACKGROUND

Oil/water separation is common in the hydrocarbon industry. In hydrocarbon recovery operations, water frequently comes into contact with hydrocarbons such as oil, and can become intermingled with the hydrocarbon. When the operation is finished, water with hydrocarbon cannot be discharged to the environment.

Separations are typically performed to separate water from oil. As is commonly known, oil typically separates from water spontaneously. Properties of the oil and the water influence how quickly and completely the separation occurs. For example, in most cases oil will form an emulsion with water that can take some time to separate. The time required for water droplets dispersed in a crude oil to diffuse and coalesce together depends on chemical and physical properties of the oil and water, droplet size of the water in the oil, and relative amounts of oil and water in the emulsion.

To minimize the time needed for separation, and therefore the size of equipment needed to provide the requisite residence time, demulsification systems are used to speed separation of oil/water emulsions. Typically, a demulsification chemical or mixture is added to the emulsion. Effectiveness of the demulsifier, and therefore the amount of demulsifier used, depends at least in part on how thoroughly the demulsifier is mixed into the oil/water emulsion. To work effectively, the demulsifier must diffuse through the oil phase, reach the water droplets, and concentrate to an extent on the surface of the water droplets. Better mixing results in faster deployment of the demulsifier to the water droplets, which results in better separation efficiency, leading to less use of expensive demulsifier. Thus, there is a continuing need in the art for demulsifier injection systems that achieve enhanced mixing and effectiveness of oil/water demulsifier systems.

### SUMMARY

Embodiments described herein provide an additive injection system, comprising a mixing conduit having a first end, a second end opposite the first end, and a wall connecting the first end to the second end; a fluid inlet formed in the wall between the first end and the second end; a fluid outlet formed in the wall between the first end and the second end; an injection conduit fluidly connecting the fluid inlet with the outlet; a pump disposed in the injection conduit; an additive conduit fluidly coupled to the injection conduit; and a jet mixer disposed in the fluid inlet.

Other embodiments described herein provide a mixing apparatus, comprising a mixing conduit having a wall, a first end, and a second end opposite the first end; a fluid inlet formed in the wall between the first end and the second end; a fluid outlet formed in the wall between the first end and the second end; an injection conduit fluidly connecting the fluid inlet with the outlet; a pump disposed in the injection conduit; an additive conduit fluidly coupled to the injection conduit; and a jet mixer that fluidly couples the fluid inlet to an interior of the mixing conduit.

Other embodiments described herein provide a method of separating a liquid mixture, comprising flowing the liquid mixture through a mixing conduit; flowing a portion of the liquid mixture through an injection conduit; adding a demulsifier to the injection conduit; mixing the demulsifier into the portion of the liquid mixture in the injection conduit to form a concentrate; and injecting the concentrate into the mixing conduit.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1 is a process diagram of a flow mixing apparatus according to one embodiment.

FIG. 2A is a cross-sectional view of a fluid inlet with a jet mixer according to one embodiment.

FIG. 2B is a cross-sectional view of the jet mixer of FIG. 2A taken along a major axis of the jet mixer.

FIG. 2C is a cross-sectional view of the jet mixer of FIG. 2A taken perpendicular to the major axis.

FIG. 2D is a detail view of one embodiment of a jet plug for use in the jet mixer of FIG. 2A.

FIG. 2E is a detail view of another embodiment of a jet plug for use in the jet mixer of FIG. 2A.

FIG. 3 is a schematic cross-sectional view of a fluid inlet according to another embodiment.

FIG. 4 is a flow diagram summarizing a method 400 according to another embodiment.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

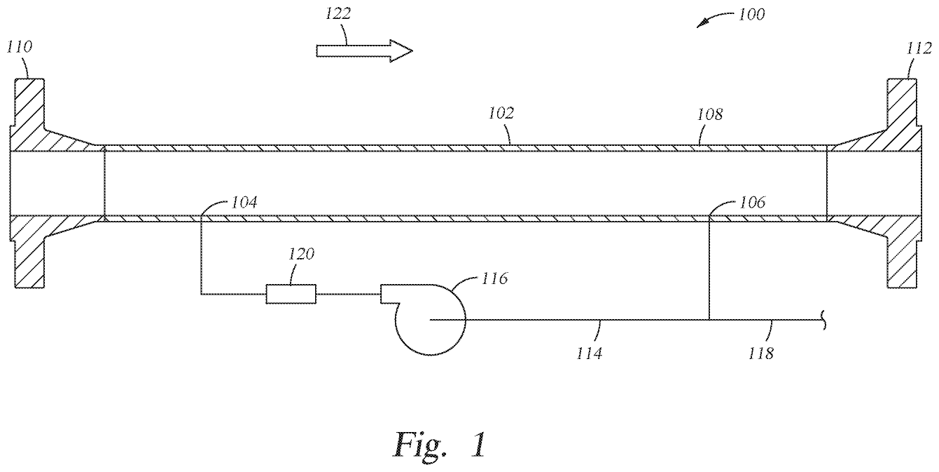

FIG. 1 is a cross-sectional view of a flow mixing apparatus 100 according to one embodiment. The flow mixing apparatus 100 features a mixing conduit 102 with a fluid inlet 104 and a fluid outlet 106, each formed in a wall 108 of the mixing conduit 102. The mixing conduit 102 has a first end 110 and a second end 112 opposite the first end. The first and second ends 110 and 112 are shown here with flanges, which may be used for convenient attachment. An injection conduit 114 fluidly couples the fluid inlet 104 with the fluid outlet 106. A pump 116 is disposed in the injection conduit 114. An additive conduit 118 is coupled to the injection conduit 114. The mixing conduit 102 typically has a primary flow direction, shown here by arrow 122. In FIG. 1, the fluid outlet 106 is downstream from the fluid inlet 104 in the flow direction. In other embodiments, the fluid outlet 106 can be upstream of the fluid inlet 104 in the flow direction.

The mixing apparatus 100 can be used to provide good mixing of an additive, provided through the additive conduit 118, into a fluid flowing through the mixing conduit 102. A portion of the fluid flowing through the mixing conduit 102 is drawn into the injection conduit 114 through the fluid outlet 106. In the injection conduit 114, the additive is added through the additive conduit 118 upstream of the pump 116. The pump 116 then raises the pressure of the mixture for injection into the mixing conduit 102 through the fluid inlet 104. In the embodiment of FIG. 1, the pump 116 mixes the fluid flowing through the injection conduit 114, which includes additive material and material from the mixing conduit 102. It should be noted that some additive material may be effectively recycled through the injection conduit 114.

The flow mixing apparatus 100 may include a static mixer 120 disposed in the injection conduit 114 between the pump 116 and the fluid inlet 104. The static mixer 120 may be used to enhance mixing in the injection conduit 114 if the pump 116 mixes the stream insufficiently, or if the mixture separates more than desired prior to the fluid inlet 104. The static mixer 120 may have one mixing stage or a plurality of mixing stages, for example 2 to 36 stages.

The flow mixing apparatus 100 can be used to provide enhanced mixing of additives into a flowing emulsion stream flowing through the mixing conduit 102. High shear dispersion of the additive from the additive conduit 118 is performed using a portion of the emulsion to avoid subjecting the entire emulsion to droplet-shrinking shear that would be counterproductive for an emulsion separation operation. The additive is dispersed in the injection conduit 114, and then the dispersed additive mixture is injected into the main flowing stream at the fluid inlet 104 using lower shear means so that the additive can be finally mixed into the full emulsion effectively.

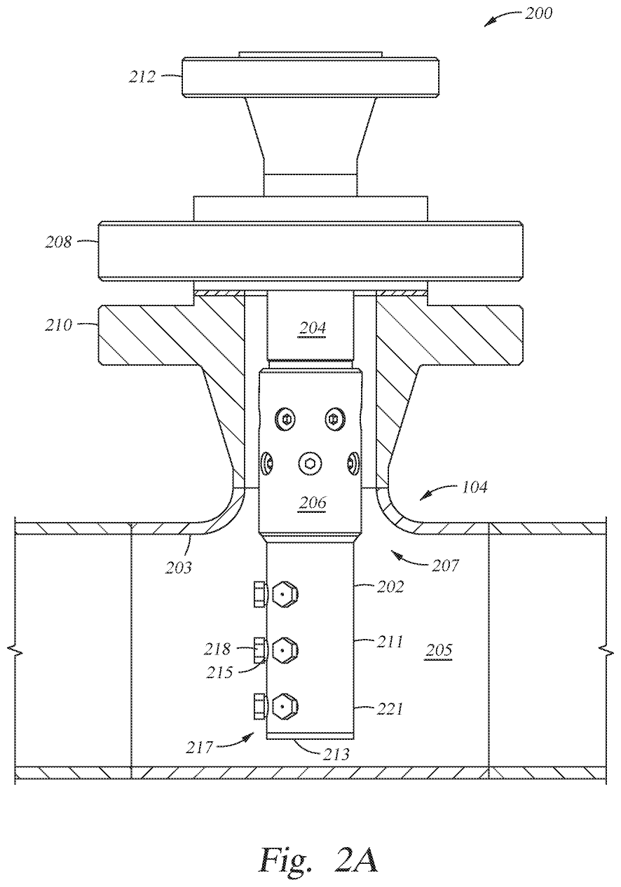

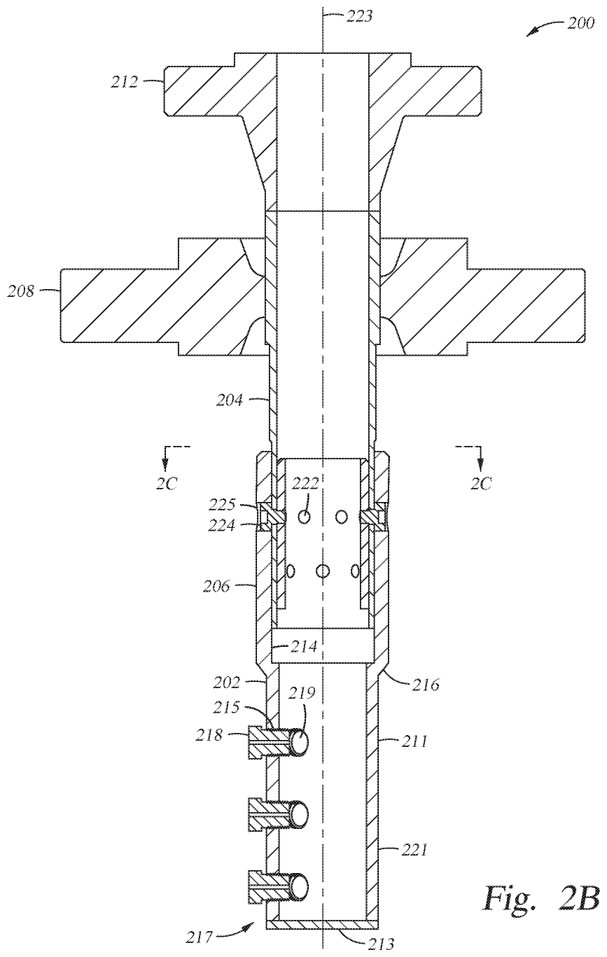

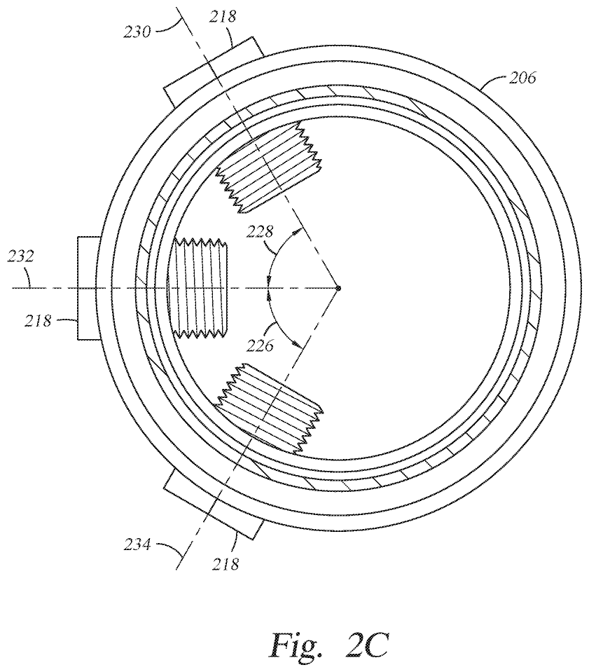

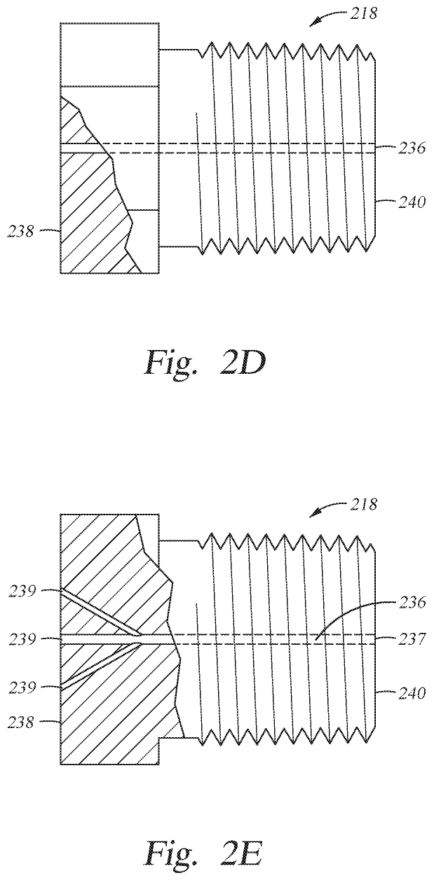

The fluid inlet 104 may include a jet mixer in some embodiments. FIG. 2A is a cross-sectional view of a fluid inlet 104 with a jet mixer 200 coupled thereto. The jet mixer 200 features a nozzle 202 that extends from an interior wall 203 of the fluid inlet 104 into an interior 205 of the fluid inlet 104. The nozzle 202 is a fluid conduit that fluidly couples the injection conduit 114 (FIG. 1) to the interior 205 of the fluid inlet 104. The nozzle 202 is inserted through an opening 207 formed in the interior wall 203 of the fluid inlet 104.

The nozzle 202 is a cylindrical member with a wall 211 and a closed end 213. A plurality of openings 215 are formed in the wall 211. The openings 215 provide a flow pathway for fluid under pressure to jet into the interior 205 of the fluid inlet 104. The jetting fluid provides mixing action in the interior 205 of the fluid inlet 104 as fluid flows along the flow mixing apparatus 100. The openings 215 are circular here, but may be any shape.

The nozzle 202 features a nozzle head 217 with a sleeve 206 that couples to a connector 204 of a flanged fitting 212. The flanged fitting 212 has a flange 208 that couples to a flange 210 of the fluid inlet 104, and the connector 204 projects into the opening 207. The nozzle head 217 fits around the connector 204 and is connected to the connector 204 by one or more fasteners (not shown here). The nozzle head 217 has a length selected based on the diameter of the mixing conduit 102 and/or the fluid inlet 104 at the inner wall 203. Depending on the mixing characteristics desired, the nozzle head 217 may extend almost completely across the mixing conduit 102 or only partway across the mixing conduit 102. Diameter of the nozzle head 217 can be selected for ease of use and insertion into the fluid inlet 104. Such nozzle heads can be used in 4″ pipes up to the largest pipes in industrial use.

Length of the nozzle 202 is determined by length of the nozzle head 217, which can be changed by installing different nozzle heads 217 on the connector 204. Each nozzle head 217 useable to form a nozzle 202 as shown here has a sleeve 206 with a length suitable to couple to the connector 204. Each nozzle head 217 has a dispersion portion 221 connected to the sleeve 206, and the dispersion portions 221 of different nozzle heads 217 can have different lengths. A nozzle head 217 for use in a 4″ pipe may have a dispersion portion 221 with a length of about 75 mm, for example. A nozzle head 217 for use in a 6″ pipe may have a dispersion portion 221 with a length of about 90 mm. Each of the foregoing nozzle heads 217 will have a sleeve 206 that is the same length to fit onto the same connector 204, for example about 100 mm.

In some cases, the flow mixing apparatus 100, with the jet mixer 200 in the fluid inlet 104, can be used to treat an oil/water mixture with additives that promote separation of the oil and water. Oil/water mixtures commonly form relatively durable emulsions that take time to separate on their own. To expedite processing and minimize equipment cost, additives such as demulsifiers are used to expedite separation of the oil and water. For such applications, the emulsion typically takes the form of water droplets suspended in an oil continuum. For the demulsifier to work effectively, the demulsifier must diffuse to the oil/water interface. This diffusion step can limit the effectiveness of the demulsifier in separating the emulsion, resulting in increased used of expensive demulsifier chemicals. Using a jet mixer such as the jet mixer 202 provides fluid shear and particle velocity, which increases diffusion surface area between oil and water and expedites movement of additives through the mixture but is not sufficient to substantially reduce droplet size of the emulsion. The openings 215 are generally sized to provide a linear flow velocity of about 1 m/sec to about 30 m/sec, such as about 2 m/sec to about 10 m/sec. for example about 3 m/sec. In some cases, a jet mixer as described herein is configured to provide a linear flow rate for each jet, or a total linear flow rate, from about 1 m/sec to about 50 m/sec, such as from about 10 m/sec to about 30 m/sec, for example about 5 m/sec or about 10 m/sec, of the mixed concentrate into the liquid mixture in the mixing conduit.

FIG. 2B is a cross-sectional view of the jet mixer 200 taken along a major axis 223 of the jet mixer 200. The openings 215 are here arranged in a linear arrangement that extends in the direction of the major axis 223 of the jet mixer 200. In this example, the sleeve 206 has an outer diameter that is greater than an outer diameter of the dispersion portion 221. Each of the openings 215 has a jet plug 218 disposed therein to provide liquid jets from the nozzle 202 into the interior 205 of the fluid inlet 104. As shown here, each jet plug 218 has a passage therethrough to flow liquid from the nozzle 202 into the fluid inlet 104. In some cases, one or more of the openings 215 may have a plug or stop that does not have a passage, so that only some of the openings 215 result in jets. Thus, a first plurality of the openings 215 might have jet plugs while a second plurality of the openings (not visible in FIG. 2B) have stops 219 inserted in them.

The jet plugs 218 also allow different shaped jets to be used under different circumstances. For example, jet plugs having circular jets can be used (i.e. jets having a circular cross-sectional shape), or jet plugs having square or triangular jets can be used. In one example, the jet plug can have a v-shaped passage to form a v-shaped jet. Use of jet plugs allows nozzle performance to be configured by changing the jet plugs when different performance is desired. The circular plugs can be replaced, for example, with v-shaped plugs. The passages of the jet plugs may also have flow profiles selected to achieve specific results. For example, shear can be increased or decreased at the passage outlet by shaping the passage outlet. If the passage outlet is slightly flared, shear at the passage outlet is decreased, while if the passage outlet is slightly crimped, shear at the passage outlet is increased. Additionally, walls of the passage can be scored or fluted near the passage outlet to provide additional surface area of the passage outlet.

The connector 204 engages with the sleeve 206 to provide a fluid connection from the additive conduit 114 to the fluid inlet 104. The sleeve 206 is fastened to the connector 204 by one or more fasteners 224 disposed through openings 225 in the sleeve 206 and openings 222 in the connector 204. The openings 225 in the sleeve 206 are aligned with at least some of the openings 222 in the connector 204, and the fasteners 224 are installed to secure the nozzle head 217 to the connector 204. A plurality of the openings 222 in the connector 204 are provided to allow for different angular orientations of the nozzle head 217 and different extension lengths of the nozzle head 217. In the embodiment shown here, the openings 222 are arranged in two rows, each row at a different location along the length of the connector 204. The nozzle head 217 is shown fastened to the connector 204 at a first opening 222 in a first row of openings, but the nozzle head 217 could also be fastened to the connector 204 at a second opening 222 in a second row of openings. In two such orientations, the nozzle 202 will have different overall length, such that the dispersion portion 221 extends further from the connector 204. The openings 222 are also distributed around the connector 204 at different angular locations to provide options for orienting the nozzle head 217 at different lateral angles. Thus, the nozzle head 217 can be oriented to a first direction with respect to the flow direction 122 (FIG. 1) and fastened in place by installing the fasteners 224, or the nozzle head 217 can be oriented to a second direction with respect to the flow direction 122 and likewise fastened in place. The location and orientation of a nozzle head 217 can be changed by removing the fasteners 224, rotating the nozzle head 217 to align the openings 225 of the nozzle head 217 with different openings 222 of the connector 204, and/or moving the nozzle head 217 (i.e. extending or retracting the nozzle head 217) to align the openings 225 of the nozzle head 217 from alignment with a first row of the openings 222 to a second row of the openings 222. The fasteners 224 can then be re-installed to secure the nozzle head 217 in the new position. In the embodiments illustrated herein, the nozzle 202 is generally arranged in the fluid inlet 104 such that the openings 215 face upstream in a flow direction of the flow mixing apparatus 100.

The openings 215 are shown here arranged in columns, which means that a first opening 215 at a first location along the major axis 223 of the nozzle 204 can be associated with a second opening 215 at a second location along the major axis 223 in a way that a straight line can be drawn from the center of the first opening 215 to the center of the second opening 215, and the line is parallel to the major axis 223. In alternate embodiments, the openings 215 may be staggered such that the line between the centers of openings at different axial locations is not parallel to the major axis 223. In such cases, the first opening at the first axial location may have an angular displacement with respect to the second opening at the second axial location. In FIG. 2B, three openings 215 are shown aligned in a column, but any or all of the three openings might have angular displacement with respect to the others. In cases with multiple such openings, the openings might be arranged in rows having different axial displacements, with angular spacing between the openings equal from row to row, and where the openings of a first row have a first angular position, the openings of a second row adjacent to the first row have a second angular position, the second angular position being different from the first angular position by a delta, where the delta is the same for each neighboring pair of rows, such that the positions of the openings shift around the circumference of the nozzle head 217 from row to row. In other cases, the openings in adjacent rows might have alternating angular displacements in a back-and-forth pattern.

FIG. 2C is a cross-sectional view of the jet mixer 200 taken perpendicular to the major axis 223, through the connector 204, and looking toward the nozzle head 217 (the location and orientation of the cross-section of FIG. 2C is indicated in FIG. 2B). The sleeve 206 is visible around the outside of the structure. Three jet plugs 218 are shown in the view of FIG. 2C. Together with FIG. 2B, the jet plugs 218 are shown in three columns located at three different angular positions. A first column 230 of jet plugs 218 is located at a first angular position. A second column 232 of jet plugs 218 is located at a second angular position displaced from the first angular position by a first angular displacement 228. A third column 234 of jet plugs 218 is located at a third angular position displaced from the second angular position by a second angular displacement 226, such that the third angular position is displaced from the first angular position by the sum of the first angular displacement 228 and the second angular displacement 226. Here, the three columns of jet plugs 218 are shown distributed with equal angular displacements. That is, the second angular displacement 226 is equal to the first angular displacement 228. In other words, the second column 232 of jet plugs 218 is equidistant from the first column 230 and the third column 234. In this case, the uniform angular displacement of the openings 215 and the jet plugs 218 is 60°, so that the first angular displacement 228 is 60° and the second angular displacement 226 is 60°. Because the sum of the first and second angular displacements 228 and 226 is less than 180°, the openings 215 and jet plugs 218 may be said to be on one side of the nozzle head 217 (i.e. one side of a plane through the major axis 223 of the jet mixer 200). The total angular displacement covered by the openings 215 and jet plugs 218, which in this case is equal to the sum of the first and second angular displacements 228 and 226, may be from 30° to 150°. The arrangement of FIG. 2C provides a spread pattern for the jets injected in an upstream direction into the liquid flowing through the mixing conduit 102 at the fluid inlet 104.

The openings 215 and jet plugs 218 are also shown here arranged in rows along the major axis 223, each row defining a plane perpendicular to the major axis 223. In this case, there are three rows (FIG. 2B), but there may be more rows or fewer rows, including only one row in some cases. The rows may be equally spaced along the major axis 223, or the spacing may vary.

In some cases, the angular spacing and/or location of the openings 215 and jet plugs 218 in one row may be different from that in other rows. For example, the rows may be staggered such that the openings 215 of one row are not aligned with the openings 215 of an adjacent row. So, in a back-and-forth embodiment, the angular range of the openings 215 in each row may be the same, for example 60°, but the angles (i.e. a bisector ray of the angular range) may point in different directions that alternate back-and-forth. Thus, the overall angular spread of all the openings 215 is more than 60°, as defined by the variation in direction of the individual rows, while each row has an angular range of only 60°. Although this example is based on individual angular ranges of 60° for each row of openings 215, similar arrangements can be made with rows having individual angular ranges more or less than 60°.

FIG. 2D is a detail view of a jet plug 218 according to one embodiment. The jet plug 218 has a first end 238, a second end 240 opposite from the first end 238, and a passage 236 from the first end 238 to the second end 240 through the interior of the jet plug 218. The passage 236 allows fluid to flow through the jet plug 218 and emerge at the first end 238 in a jet. The passage 236 is formed by boring a hole through a bolt-like plug.

In FIG. 2D the passage 236 has no special flow features, but as described above such flow features may be included. In other aspects, the openings 215, or the passages 236, may have flow axes that direct the jet through the opening 215 in a desired direction, for example a direction different from a radial direction of the nozzle head 217 or an axial direction that partly extends along the major axis 223. Many different such directions can be provided to increase turbulence and mixing in the interior 205 of the fluid inlet 104.

In other examples, a jet plug 218 may have multiple outlets pointing in multiple directions. FIG. 2E shows such an embodiment. The jet plug of FIG. 2E has a passage 236 with a single inlet opening 237 and a plurality of outlet openings 239.

The jet mixer 200 described in connection with FIGS. 2A-2E can be used in the fluid inlets described herein, such as the fluid inlet 104, and can be used to practice the methods described herein.

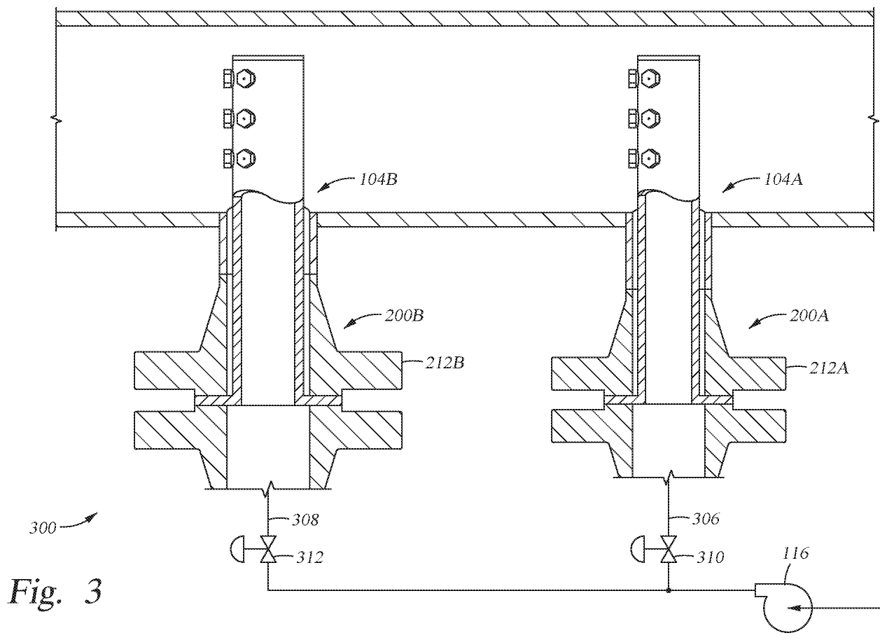

FIG. 3 is a schematic cross-sectional view of a fluid inlet 300 according to another embodiment. In this case, the fluid inlet 300 includes two jet mixers, a first jet mixer 200A and a second jet mixer 200B. The jet mixers 200A and 200B are embodiments of the jet mixer 200 described in connection with FIGS. 2A-2E. The fluid inlet 300 can be used in place of the fluid inlet 104 in the apparatus 100, and can be used to practice the methods described here.

The fluid inlet 300 is used to provide jet mixing at different overall flow rates. Mixing effectiveness of a jet mixer depends on the jet velocity in comparison to the velocity and volume of the flow into which the jet is injected. As overall flow rate through the mixing conduit 102 changes, jet velocity might need to be adjusted upward or downward to maintain a desired mixing effectiveness. If a desired jet velocity is not available using one jet mixer, the fluid inlet 300 provides additional flexibility to maintain mixing by choosing the first jet mixer 200A or the second jet mixer 200B.

The jet mixers 200A and 200B are different sizes. The second jet mixer 200B is larger than the first jet mixer 200A to deliver higher volumetric flow rate at a given jet velocity. A first control valve 310 can be coupled to the first jet mixer 200A via a first control valve line 306 and a first flanged fitting 212A sized for the first jet mixer 200A. A second control valve 312 can be coupled to the second jet mixer 200B via a second control valve line 308 and a second flanged fitting 212B sized for the second jet mixer 200B. The first and second control valves 310 and 312 can be coupled to the injection conduit 114 of the apparatus 100.

The first and second control valves 310 and 312 can be used to select a flow rate through the first and second jet mixers 200A and B in order to accomplish a desired mixing effectiveness in the mixing conduit 102 using the fluid inlet 300. As noted above, the nozzles of the first and second jet mixers 200A and B can be configured to have different jet patterns, to point jets in different directions, and to mix at different lateral locations within the fluid inlet 300. The first and second jet mixers 200A and B can be used together or individually.

If mixing effectiveness is measured downstream of the fluid inlet 300 or the fluid inlet 104, mixing can be adjusted to improve mixing effectiveness. In a system of separable liquids, mixing effectiveness where an additive is being mixed into the system can be generally expressed using the concentration of the additive in the phases of the separable liquids. The fluid flowing in the mixing conduit 102 can be sampled by a sensor, or a physical sample of the fluid can be analyzed, to determine a metric of mixing effectiveness. Using the fluid inlet 104 of the apparatus 100, flow rate through the injection conduit 114 can be changed, and/or amount of additive from the additive source 118 can be changed, to adjust mixing effectiveness. Using the fluid inlet 300 in the apparatus 100 in place of the fluid inlet 104, total flow rate through the injection conduit 114 and/or amount of additive from the additive source 118 can be changed. Flow rate through the first or second jet mixers 200A and B can also be changed. For example, in a high flow scenario, more flow can be routed through the larger second jet mixer 200B, and if overall flow rate drops, flow rate through the second jet mixer 200B can be incrementally decreased and flow rate through the smaller first jet mixer 200A can be incrementally increased using the control valves 310 and 312.

It should be noted that the first and second jet mixers 200A and 200B are shown installed in the same side of the fluid inlet 300, but the two jet mixers 200A and 200B may be installed in any desired relative orientation. Additionally, more than two jet mixers 200 may be used if additional turndown capability is needed.

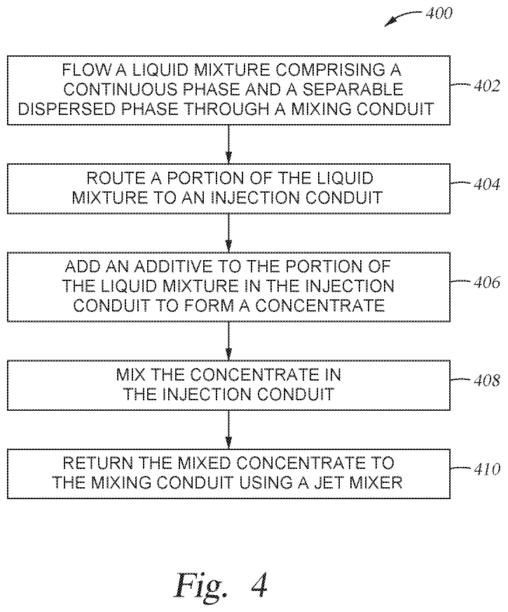

FIG. 4 is a flow diagram summarizing a method 400 according to another embodiment. The method 400 may be practiced using any of the apparatus of FIGS. 1-3. The method 400 is a method of separating liquids in a separable liquid mixture by use of an additive that promotes separation of the mixture. A separable liquid mixture typically includes a continuous liquid phase and one or more dispersed liquid phases. Use of an additive to promote separation of the liquids usually involves enhancing coalescence of the dispersed liquids by diffusing the additive into the dispersed liquid phases. In many cases, the dispersed liquid phases are in the form of small droplets or particles spread throughout the continuous liquid phase in an emulsion or quasi-emulsion. The method 400 accomplishes rapid diffusion of the additive to the dispersed particles without substantially further reducing particle size of the dispersed particles.

At 402, a liquid mixture comprising at least two separable liquid phases in a continuous phase and at least one dispersed phase is flowed through a mixing conduit. The mixing conduit is typically a fluid flow conduit having any convenient shape, such as a pipe. The liquid mixture may be heated in the mixing conduit, using a jacket or in-line heater of any suitable type, to promote mixing or diffusion of an additive, or to promote separation of the mixture.

At 404, a portion of the liquid mixture is routed to an injection conduit. The portion of the liquid mixture is obtained from a fluid outlet coupled to the mixing conduit. The injection conduit typically has a short length such that residence time in the injection conduit is comparable to residence time in the mixing conduit. The injection conduit may be configured to promote turbulent flow, for example by including turbulation features such as orifices and/or baffles in the injection conduit, to maintain the liquid mixture in a dispersion state in the injection conduit. To ultimately blend an additive into the liquid mixture in the mixing conduit, it can be helpful in many cases to maintain at least a weak dispersion or emulsion in the injection conduit.

At 406, an additive is added to the portion of the liquid mixture in the injection conduit to form a concentrate. In the case where the additive is a demulsifier, the additive is added in an amount that does not result in excessive separation of the liquid mixture in the injection conduit. For example, a demulsifier may be added to an oil/water emulsion up to a mass fraction of about 5%, depending on the nature of the specific oil/water emulsion. The mass fraction of demulsifier in the injection conduit can be from about 0.001% up to about 80%. The mixture in the injection conduit can also be heated, if desired, to maintain the mixture in a desired state. In the case of demulsifiers, the mixing apparatus described herein make possible the use of neat or concentrated demulsifiers, for example demulsifier concentrates having demulsifier concentration of 50% or greater by weight, for example about 70% or greater. Less concentrated demulsifier compositions can also be used.

At 408, the concentrate is mixed in the injection conduit. A pump, orifice, static mixer, or any combination thereof can be used to mix the concentrate in the injection conduit. The static mixer can have from 2 to 36 stages of mixing. The mixing performed at 408 is designed to reduce diffusion path length for the additive through the continuous phase to the dispersed phase and increase phase contact surface area, resulting in a concentration of additive in the dispersed phase that yields a desired mixing effectiveness.

In one aspect, mixing effectiveness in a separable liquid system can be expressed as concentration of a mixed material in the dispersed phase divided by concentration of the mixed material in the continuous phase. If the continuous phase is called Phase 1, the dispersed phase is called Phase 2, concentration of the mixed material in Phase 1 is denoted c1, and concentration of the mixed material in Phase 2 is denoted c2, then mixing effectiveness can be expressed as the ratio c2/c1. If the liquid of Phase 1 has a carrying limit L1 of the mixed material, and the liquid of Phase 2 has a carrying limit L2 of the mixed material, specific mixing effectiveness can be expressed as the ratio (c2/L2)/(c1/L1), taking into account the carrying limits of the two phases. Theoretically perfect mixing effectiveness is obtained when either the mixing effectiveness or the specific mixing effective is equal to 1. A perfectly mixed and fully loaded separable liquid system has both mixing effectiveness and specific mixing effectiveness of 1.

A fraction of the total flow in the mixing conduit is routed to the injection conduit. The fraction is typically between about 0.1% and about 10%, for example about 1%. Mixing effectiveness in the injection conduit is a function of flow rate and types of mixing apparatus used in the injection conduit. As noted above, the fluid in the injection conduit may be mixed by use of a pump, an orifice, and/or a static mixer, all of which can be used in combination.

At 410, the mixed concentrate is returned to the liquid mixture in the mixing conduit. The mixed concentrate is flowed into a fluid inlet formed in the mixing conduit. The fluid inlet may be upstream of the fluid outlet or downstream of the fluid outlet. In cases where the fluid inlet is upstream of the fluid outlet, a pump may be used in the injection conduit to mix the concentrate and raise the pressure of the concentrate for return to the mixing conduit. If the fluid inlet is downstream of the fluid outlet, a pressure drop member may be included in the mixing conduit to drop the pressure of the liquid mixture so that the concentrate is returned to the liquid mixture at relatively higher pressure.

A mixer may be included at the fluid inlet for returning the mixed concentrate to the liquid mixture. The mixer may be a jet mixer, as described herein, to accomplish mixing through fluid turbulence. In some cases, the mixed concentrate may be divided into multiple streams for return to the liquid mixture so the mixed concentrate is added back to the liquid mixture in stages. A jet mixer, or another kind of mixer, can be used at each stage.

In the case where the fluid inlet is upstream of the fluid outlet, the portion of the liquid mixture flowed through the fluid outlet has an amount of the additive contained in the portion of the liquid mixture. In such cases, the amount of additive added to the injection conduit is selected such that the total amount of additive in the liquid mixture after returning mixed concentrate to the liquid mixture is a target amount. For example, in the case of demulsifier additives used to separate an oil/water emulsion, the total amount of additive added to the injection conduit results in a concentration of additive in the mixing conduit downstream of the fluid inlet that is less than 200 ppm by weight, for example 10 ppm to 100 ppm by weight. If the mass flow rate through the injection conduit prior to adding the additive is 1% of the mass flow through the mixing conduit downstream of the fluid inlet and upstream of the fluid outlet, then the additive concentration in the injection conduit to achieve the above concentration in the mixing conduit is 0.1% to 1.0% by weight.

Although the preceding description has been described herein with reference to particular means, materials, and embodiments, it is not intended to be limited to the particulars disclosed herein; rather, it extends to all functionally equivalent structures, methods, and uses, such as are within the scope of the appended claims.

What is claimed is:

1. An additive injection system, comprising:
a mixing conduit having a first end, a second end opposite the first end, and a wall connecting the first end to the second end;
a fluid inlet formed in the wall between the first end and the second end;
a fluid outlet formed in the wall between the first end and the second end;
an injection conduit fluidly connecting the fluid inlet with the fluid outlet;
a pump disposed to pump fluid in the injection conduit;
an additive conduit fluidly coupled to the injection conduit; and
a jet mixer disposed in the fluid inlet.

2. The apparatus of claim 1, wherein the fluid outlet is located between the fluid inlet and the second end.

3. The apparatus of claim 1, further comprising a static mixer disposed in line with the injection conduit.

4. The apparatus of claim 1, wherein the jet mixer comprises a nozzle extending into the mixing conduit, the nozzle having openings only on one side.

5. The apparatus of claim 4, wherein the mixing conduit has a primary flow direction, and the openings are on a side of the nozzle that faces upstream in the primary flow direction.

6. The apparatus of claim 5, wherein the openings on the side of the nozzle span an angle of 30 degrees to 150 degrees.

7. The apparatus of claim 5, wherein each of the openings on the side of the nozzle includes a jet plug.

8. The apparatus of claim 1, further comprising a second jet mixer disposed in the fluid inlet.

9. The apparatus of claim 1, wherein the fluid inlet comprises a jet mixer and the injection conduit comprises a static mixer.

10. A mixing apparatus, comprising:
a mixing conduit having a wall, a first end, and a second end opposite the first end;
a fluid inlet formed in the wall between the first end and the second end;
a fluid outlet formed in the wall between the first end and the second end;
an injection conduit fluidly connecting the fluid inlet with the fluid outlet;
a pump disposed to pump fluid in the injection conduit;
an additive conduit fluidly coupled to the injection conduit; and
a jet mixer that fluidly couples the fluid inlet to an interior of the mixing conduit.

11. A method of separating a liquid mixture, comprising:
flowing the liquid mixture through a mixing conduit;
flowing a portion of the liquid mixture through an injection conduit;
adding a demulsifier to the injection conduit;
mixing the demulsifier into the portion of the liquid mixture in the injection conduit to form a concentrate; and
injecting the concentrate into the mixing conduit.

12. The method of claim 11, wherein injecting the concentrate into the mixing conduit comprises flowing jets of the concentrate into the mixing conduit.

13. The method of claim 12, wherein a velocity of each jet is from about 1 m/sec to about 50 m/sec.

14. The method of claim 11, wherein adding the demulsifier comprises adding a solution of a demulsifying agent in a solvent, wherein a concentration of the demulsifying agent in the solvent is at least about 30% by weight.

15. The method of claim 14, wherein a concentration of the demulsifying agent in the mixing conduit is less than about 200 ppm by weight.

16. The method of claim 11, wherein injecting the concentrate into the mixing conduit comprises injecting a first portion of the concentrate at a first location of the mixing conduit and injecting a second portion of the concentrate at a second location of the mixing conduit different from the first location.

17. The method of claim 12, wherein mixing the demulsifier into the portion of the liquid mixture in the injection conduit comprises flowing the demulsifier and the portion of the liquid mixture through a static mixer.

18. The method of claim 17, further comprising pumping the demulsifier and the portion of the liquid mixture through the static mixer.

19. The method of claim 11, wherein adding the demulsifier to the injection conduit comprises flowing a demulsifier mixture comprising a demulsifier in a concentration of 50% to 100% by weight into the injection conduit.

20. The method of claim 19, wherein mixing the demulsifier into the portion of the liquid mixture in the injection conduit to form a concentrate comprises pumping the portion of the liquid mixture, with the demulsifier, through a static mixer, and wherein injecting the concentrate into the mixing conduit comprises flowing jets of the concentrate at a velocity of 1 m/sec to 50 m/sec into the mixing conduit.
